(19) United States
(12) Patent Application Publication
(10) Pub. No.: US 2014/0328254 A1
(43) Pub. Date: Nov. 6, 2014

(54) METHOD FOR RE-SELECTING AP IN WIRELESS COMMUNICATION SYSTEM, AND DEVICE FOR SAME

(71) Applicant: LG ELECTRONICS INC., Seoul (KR)

(72) Inventor: Jaewon Lim, Anyang-si (KR)

(73) Assignee: LG ELECTRONICS INC., Seoul (KR)

(21) Appl. No.: 14/361,628

(22) PCT Filed: Dec. 17, 2012
(86) PCT No.: PCT/KR2012/010992

§ 371 Date: May 29, 2014

Related U.S. Application Data
(60) Provisional application No. 61/576,970, filed on Dec. 16, 2011.

(51) Int. Cl. H04W 48/20; H04W 84/12

(52) U.S. Cl. CPC H04W 48/20; H04W 84/12
USPC 370/328

(57) ABSTRACT

The method performed by a base station and comprises receiving, from a terminal connected to a first WLAN AP, an AP re-selection response message requesting a connection change from the first WLAN AP to a second WLAN AP; transmitting, to the second WLAN AP, an AP change request message including information relating to the association of the terminal and information relating to the connection setup of the terminal; receiving, from the second WLAN AP, an AP change response message including information indicating approval, or not, of the connection of the terminal; if the second WLAN AP has provided approval, transmitting, to the first WLAN AP, an AP change indication message indicating the connection change of the terminal; and transmitting, to the terminal, an AP re-selection command message ordering connection with the second WLAN AP.

### FIELD OF THE INVENTION

The present invention relates to a wireless communication system and, more particularly, to a method for re-selecting a WLAN (Wireless Local Area Network) AP (Access Point) in a wireless communication system supporting a multiple Radio Access Network and a device for supporting the same.

### BACKGROUND ART

A standard for Wireless Local Area Network technology is being developed as an IEEE (Institute of Electrical and Electronics Engineers) 802.11 standard. IEEE 802.11a and b use an unlicensed band at 2.4. GHz or 5 GHz, and IEEE 802.11b provides a transmission rate (or transmission speed) of 11 Mbps, and IEEE 802.11a provides a transmission rate of 54 Mbps. IEEE 802.11g provides a transmission rate of 54 Mbps, by applying OFDM (Orthogonal frequency-division multiplexing) at 2.4 GHz. IEEE 802.11n provides a transmission rate of 300 Mbps with respect to 4 spatial streams, by applying MIMO-OFDM (multiple input multiple output-OFDM). And, IEEE 802.11n supports a channel bandwidth of up to 40 MHz, and, in this case, IEEE 802.11n provides a transmission rate of 600 Mbps.

### DETAILED DESCRIPTION OF THE INVENTION

### Technical Objects

An object of the present invention is to propose a method for easily transceiving (transmitting/receiving) data between user equipments in a wireless communication system and, preferably, in a wireless communication system supporting a multiRadio Access Network, and a device for the same.

Additionally, an object of the present invention is to propose a method for performing in advance procedures required for WLAN AP re-access of a user equipment through a cellular network, when performing WLAN AP shift of the user equipment, and a device for the same.

The technical objects of the present invention will not be limited only to the objects described above. Accordingly, technical objects that have not been mentioned above or additional technical objects of the present application may become apparent to those having ordinary skill in the art from the description presented below.

### Technical Solutions

In an aspect of the present invention, as a method for reselecting a WLAN (Wireless Local Area Network) AP (Access Point) in a wireless communication system supporting multi Radio Access Network, the AP reselection method includes the steps of having a base station receive an AP reselection response message requesting access to be changed from a first WLAN AP to a second WLAN AP from a user equipment accessing the first WLAN AP, having the base station transmit an AP change request message including information related to association of the user equipment and information related to connection setup to the second WLAN AP, having the base station receive an AP change response message including information indicating whether or not access of the user equipment has been approved from the second WLAN AP, in case the second WLAN AP has approved the access, having the base station transmit an AP change indication message for indicating access change of the user equipment to the first WLAN AP and having the base station transmit an AP reselection command message commanding access to the second WLAN AP to the user equipment.

In another aspect of the present invention, as a base station performing WLAN (Wireless Local Area Network) AP (Access Point) reselection in a wireless communication system supporting multi Radio Access Network, the base station includes an RF (Radio Frequency) unit configured to transceive a radio signal and a processor configured to receive an AP reselection response message requesting access to be changed from a first WLAN AP to a second WLAN AP from a user equipment accessing the first WLAN AP, to transmit an AP change request message including information related to association of the user equipment and information related to connection setup to the second WLAN AP, to receive an AP change response message including information indicating whether or not access of the user equipment has been approved from the second WLAN AP, to transmit an AP change indication message for indicating access change of the user equipment to the first WLAN AP, in case the second WLAN AP has approved the access, and to transmit an AP reselection command message commanding access to the second WLAN AP to the user equipment.

Preferably, alternatively or additionally, the method further includes a step of having the base station receive a neighboring cell report message including an identifier of a WLAN AP searched by the user equipment and signal intensity information from the user equipment.

Preferably, alternatively or additionally, when the user equipment requires access to be changed from the first WLAN AP to the second WLAN AP, based upon the neighboring cell report message, the method further includes a step of having the base station transmit an AP reselection request message requesting for an access change from the first WLAN AP to the second WLAN AP to the user equipment.

Preferably, alternatively or additionally, when data of the user equipment begin to be forwarded to the second WLAN AP from the first WLAN AP, the method further includes a step of having the base station receive an AP change setup complete message indicating that preparations required for the access of the user equipment have been completed from the second WLAN AP.

Preferably, alternatively or additionally, the AP reselection response message further includes at least any one of an identifier of the user equipment, capability information of the user equipment, association identifier (AID) with the first WLAN AP, an identifier of the first WLAN AP, and an identifier of the second WLAN AP.

Preferably, alternatively or additionally, the AP change request message includes information that is identical to information included in the AP reselection response message.

Preferably, alternatively or additionally, the AP change response message includes an AID (Association Identifier) of the user equipment.

Preferably, alternatively or additionally, the AP reselection command message includes information indicating whether or not access of the user equipment has been approved by the second WLAN AP and an AID (Association Identifier) of the user equipment.

### Effects of the Invention

According to the exemplary embodiment of the present invention, data may be easily transceived (transmitted/received) between user equipments in a wireless communication system and, preferably, in a wireless communication system supporting a multiple Radio Access Network.

Additionally, according to the exemplary embodiment of the present invention, by completing in advance procedures that are required for WLAN AP re-access of a user equipment through a cellular network, WLAN AP re-access of the user equipment may be easily and quickly performed.

The effects of the present invention will not be limited only to the effects described above. Accordingly, effects that have not been mentioned above or additional effects of the present application may become apparent to those having ordinary skill in the art from the description presented below.

### BRIEF DESCRIPTION OF THE DRAWINGS

The accompanying drawings, which are included as a part of the detailed description in order to provide a further understanding of the present invention, provide exemplary embodiments of the present invention and describe the technical aspects of the present invention along with the detailed description.

FIG. 1 illustrates an exemplary structure of a WLAN system.

FIG. 2 illustrates another exemplary structure of a WLAN system.

FIG. 3 illustrates yet another exemplary structure of a WLAN system.

FIG. 4 illustrates an exemplary procedure for having a user equipment access an AP in a WLAN system.

FIG. 5 illustrates an exemplary structural diagram of a network to which the present invention may be applied.

FIG. 6 illustrates an example of a WLAN AP re-selection process according to an exemplary embodiment of the present invention.

FIG. 7 illustrates an exemplary procedure of WLAN AP re-selection according to an exemplary embodiment of the present invention.

FIG. 8 illustrates a block view of a structure of a wireless communication device according to an exemplary embodiment of the present invention.

### BEST MODE FOR CARRYING OUT THE PRESENT INVENTION

Hereinafter, the preferred embodiments of the present invention will now be described in detail with reference to the accompanying drawings. The detailed description of the present invention that is to be disclosed along with the appended drawings is merely given to provide to describe the exemplary embodiment of the present invention. In other words, the embodiments presented in this specification do not correspond to the only embodiments that can be realized according to the present invention. In the following description of the present invention, the description of detailed features of the present invention will be given in order to provide full and complete understanding of the present invention. However, it will be apparent to those skilled in the art that the present invention can be realized even without the detailed features described herein.

In some cases, in order to avoid any ambiguity in the concept (or idea) of the present invention, some of the structures and devices disclosed (or mentioned) in the present invention may be omitted from the accompanying drawings of the present invention, or the present invention may be illustrated in the form of a block view focusing only on the essential features or functions of each structure and device.

In the description of the present invention, the embodiments of the present invention will be described by mainly focusing on the data transmission and reception relation between the base station and the terminal (or user equipment). Herein, the base station may refer to a terminal node of the network that performs direct communication with the terminal. Occasionally, in the description of the present invention, particular operations of the present invention that are described as being performed by the base station may also be performed by an upper node of the base station. More specifically, in a network consisting of multiple network nodes including the base station, it is apparent that diverse operations that are performed in order to communicate with the terminal may be performed by the base station or b network nodes other than the base station. The term ‘Base Station (BS)’ may be replaced by other terms, such as fixed station, Node B, eNode B (eNB), Access Point (AP), and so on. The term ‘relay’ may be replaced by terms including Relay Node (RN), Relay Station (RS), and so on. Additionally, the term ‘Terminal’ may be replaced by terms including UE (User Equipment), MS (Mobile Station), MSS (Mobile Subscriber Station), SS (Subscriber Station), AMS (Advanced Mobile Station), WT (Wireless terminal), MTC (Machine-Type Communication) device, M2M (Machine-to-Machine) device, D2D device (Device-to-Device) device, and so on.

The specific terms used in the following description of the present invention are provided to facilitate the understanding of the present invention. And, therefore, without deviating from the technical scope and spirit of the present invention, such specific terms may also be varied and/or replaced by other terms.

Herein, the embodiments of the present invention may be supported by at least one the disclosed standard documents for wireless access systems including the IEEE 802 system, the 3GPP LTE system, the LTE-A (LTE-Advanced) system, and the 3GPP2 system. More specifically, among the embodiments of the present invention, partial operation steps or structures of the present invention, which have been omitted from the description of the present invention in order to specify and clarify the technical scope and spirit of the present invention may also be supported by the above-described standard documents. Furthermore, the terms disclosed in the description of the present invention may be described based upon the above-mentioned standard documents.

The technology described below may be used in a wide range of wireless access systems, such as CDMA (Code Division Multiple Access), FDMA (Frequency Division Multiple Access), TDMA (Time Division Multiple Access), OFDMA (Orthogonal Frequency Division Multiple Access), SC-FDMA (Single Carrier Frequency Division Multiple Access), and so on. Herein, the CDMA may be realized by a radio technology such as UTRA (Universal Terrestrial Radio Access) or CDMA2000. The TDMA may be realized by a radio technology such as GSM (Global System for Mobile communications)/GPRS (General Packet Radio Service)/EDGE (Enhanced Data Rates for GSM Evolution). The OFDMA may be realized by a radio technology such as IEEE 802.11 (Wi-Fi), IEEE 802.16 (WiMAX), IEEE 802-20, E-UTRA (Evolved UTRA), and so on. The UTRA corresponds to a portion of the UMTS (Universal Mobile Telecommunications System). And, as a portion of the E-UMTS (Evolved UMTS) using the E-UTRA, the 3GPP (3rd Generation Partnership Project) LTE (long term evolution) system adopts the OFDMA in a downlink and adopts the SC-FDMA in an uplink. The LTE-A (LTE-Advanced) corresponds to an evolution of the 3GPP LTE system.

1. General Description of WLAN (Wireless Local Area Network) to which the Present Invention can be Applied

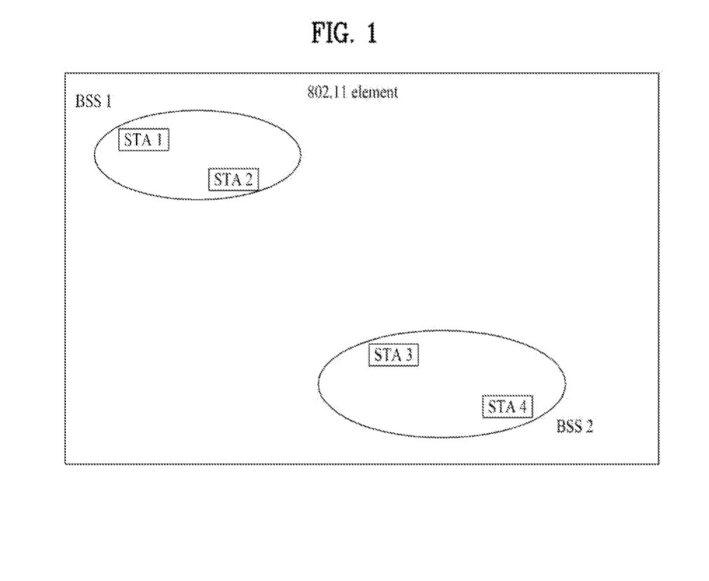

FIG. 1 illustrates an exemplary structure of a WLAN system.

Referring to FIG. 1, the WLAN system includes more than one BBS (Basic Service Set). The BBS corresponds to a group of Stations (STAs), which are successfully synchronized with one another, so as to be capable of communicating with one another. FIG. 1 shows an example of 2 BBSs and 2 STAs being accessed to each BSS. Oval markings in FIG. 1 indicate coverage areas of the BSS, and this will be referred to as a BSA (Basic Service Area). In case the STA moves outside of the boundaries of the BSA, the STA can no longer perform direct communication with another STA existing in the BSA.

The BSS is divided into IBBS (Independent BSS) and an Infrastructure BSS. The IBBS corresponds to the most basic type of the WLAN system, and the IBBS is shown in FIG. 1. In the IBBS, direct communication may be performed between STAs, and a type of such inter-STA operation is referred to as an ad hoc network.

In order to access the BSS, an STA should perform a procedure for establishing synchronization with the base station. Additionally, in order to access all services of the Infrastructure BSS, the STA should be in association with the base station. Such association procedure is performed dynamically and includes usage of a DSS (Distribution System Service).

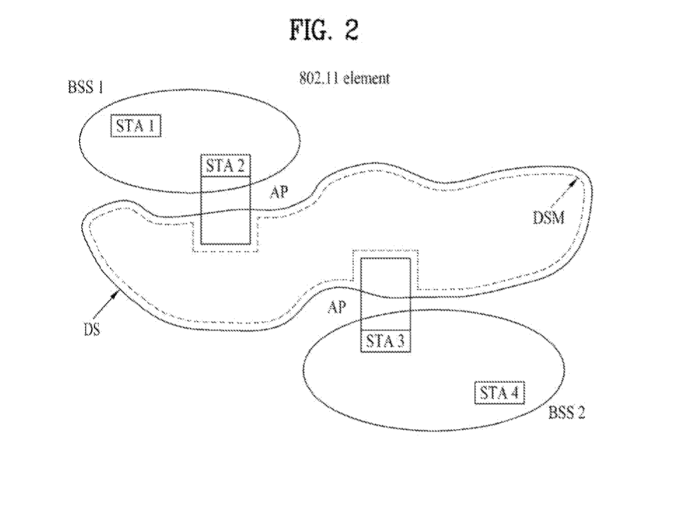

FIG. 2 illustrates another exemplary structure of a WLAN system.

A direct distance between an STA and an STA may be physically limited. Depending upon the network, this distance may be sufficient, however, if the distance is insufficient, the extension in the coverage may be required. Accordingly, the BSS may be configured as an element of an extended form of network consisting of multiple BSSs. As described above, an architecture element being used for interconnecting the BSSs is referred to as a DS (Distribution System).

As a mechanism connecting multiple APs, the DS is not necessarily required to be a network, and, if a predetermined distribution service can be provided, there is no limitation in the form of the DS. For example, the DS may correspond to a wireless network (or radio network), such as a mesh network, or may correspond to a physical architecture configured to interconnect the APs.

In the WLAN system, a DSM (Distribution System Medium) and a WM (Wireless Medium) may be logically differentiated from one another. Each logical medium may be used for a different purpose by different elements of the architecture. By having the DS provide a logical service that is required for managing seamless integration of multiple BSSs and address mapping to a destination, mobility of the device is supported.

The AP (Access Point) corresponds to an entity supporting an associated STA, so that the associated STA can access the distribution system through the WM. Data between the BSS and the DS is transported through such AP. Herein, since all APs may correspond to STAs, the AP also corresponds to an entity being assigned with an address. However, in order to perform communication through the WM and to perform communication through the DSM, the addresses used by the APs are not required to be identical to one another.

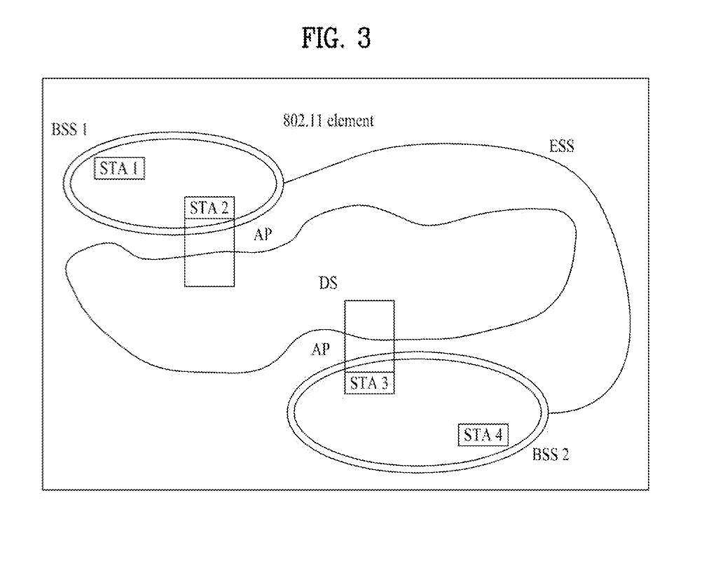

FIG. 3 illustrates yet another exemplary structure of a WLAN system.

A wireless network having an arbitrary size and complexity may be configured by using a DS and a BSS, and such network type is referred to as an ESS (Extended Service set). The ESS refers to multiple BSSs being connected through the DS and does not include a DS. Since the ESS network has an LLC (Logical Link Control) layer that is identical to the LLC layer of the IBSS layer, the STA belonging to the ESS may move transparently to the LLC to one BSS to another BSS.

In order to create physically continuous coverage, the BSSs may partially overlap (or overlay) one another. And, since there is not limitation in the logical distance between the BSSs, the BSSs may not be physically connected to one another. Additionally, in order to avoid unnecessary overlapping, one (or more than one) IBBS or ESS network may exist as one (or more than one) ESS network in physically identical space for a case when an ad hoc network is being operated in a location having an ESS network, or for a case when each WLAN system network physically overlapping one another is set up as a different architecture, or for a case when multiple access or security policies each being different from one another are being required.

As a logical entity including MAC (Medium Access Control) and a Physical Layer interface respective to a wireless medium, the above-described STA includes an AP STA (AP Station) and a Non-AP STA (Non-AP Station). Among the STAs, a mobile user equipments being manipulated by the user corresponds to a Non-AP STA, and, when simply referred to as an STA, the STA may also indicate a Non-AP STA. The Non-AP STA may also be referred to as other terms, such as a terminal, a WTRU (Wireless Transmit/Receive Unit), a UE (User Equipment), an MS (Mobile Station), a Mobile Terminal, a Mobile Subscriber Unit, and so on. Additionally, the AP corresponds to a functional entity providing access to a DS (Distribution system) to an STA (Associated Station), which is coupled to the corresponding AP, by passing through a wireless medium. The AP may also be referred to as BS (Base Station), Node-B, BTS (Base Transceiver System), Femto BS, or site controller, and so on.

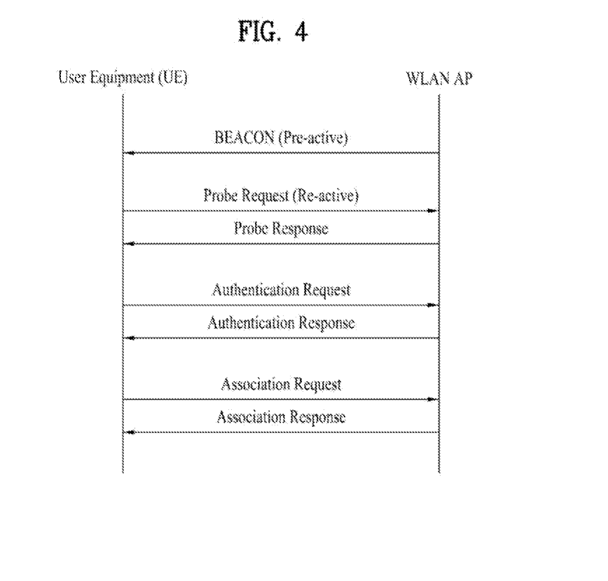

FIG. 4 illustrates an exemplary procedure for having a user equipment access an AP in a WLAN system.

Referring to FIG. 4, the AP periodically generates and transmits a broadcast type Beacon frame. After receiving the beacon frame, the user equipment detects the presence of an access point. The Beacon frame may be configured to include a header, a frame body, and an FCS (Frame Check Sequence), and the Beacon frame may include information, such as Time stamp, Beacon interval, Capability, SSID (Service Set Identifier), and Supported rates, and so on. The SSID (Service Set Identifier) corresponds to an identifier that is used for identifying multiple basic service sets each being different from one another in a WLAN system, and the SSID may also be referred to as a basic service set identifier (BSSID).

The user equipment receives a beacon frame, and the user equipment verifies the presence of multiple APs that are available for access (accessible APs) through the received beacon frames. This is referred to as passive scanning. The user equipment selects a specific AP among the multiple APs and transmits a Probe Request frame to the selected AP.

Meanwhile, the user equipment may store information on the APs to which the user equipment has already accessed as profile. After storing the information on the APs to which the user equipment has already accessed as profile, the user equipment may be capable of selecting an AP from a next profile without having to receive a beacon frame, and the user equipment may then transmit a probe request frame to the selected access point. This is referred to as active scanning.

The probe request frame may be configured to include a header, a frame body, and a frame check sequence (FCS), and the probe request frame may include information, such as Service Set Identifier (SSID), Supported rates, and so on. As described above, the service set identifier corresponds to an identifier that is used for differentiating (or identifying) the basic service set, and any user equipment that is not aware (or informed) of the unique service set identifier of a specific basic service set is incapable of accessing the correction basic service set. More specifically, in order to access a specific basic service set, i.e., in order to access an AP, the user equipment sends out a service set identifier by loading the service set identifier in a probe request frame.

After receiving the probe request frame, the AP transmits a Probe Response frame to the user equipment as a response to the probe request frame. The Probe Response frame may be configured to include a header, a frame body, and a Frame Check Sequence (FCS), and the Probe Response frame may include information, such as Time stamp, Beacon interval, capability, Service Set Identifier (SSID), and Supported rates, and so on. This series of processes is referred to as a Search procedure.

After undergoing the Search procedure, the user equipment and the AP perform an Authentication procedure. More specifically, after receiving the probe response frame from the AP, the user equipment transmits an Authentication Request frame to the AP in order to request Authentication. Thereafter, by having the AP transmit an Authentication Response frame to the user equipment, authentication between the AP and the user equipment is established. The authentication request frame and/or the authentication response frame may be configured to include a header, a frame body, and a frame check sequence (FCS), and the authentication request frame and/or the authentication response frame may include information, such as an Authentication algorithm number, an Authentication transaction sequence number, and a Status code, and so on.

After undergoing the Authentication procedure, the user equipment and the AP perform an Association procedure. More specifically, after establishing authentication between the AP and the user equipment, the user equipment transmits an Association Request frame to the AP. The Association Request frame may be configured to include a header, a frame body, and a frame check sequence (FCS), and the Association Request frame may include information, such as Capability, Listen interval, service set identifier (SSID), and supported rates, and so on.

Then, by having the AP transmit an Association Response frame to the user equipment as a response to the Association request frame, association with the user equipment is established. The association request frame may be configured to include a header, a frame body, and a frame check sequence (FCS), and the Association Request frame may include information, such as Capability, Status Code, AID (Association ID), and supported rates, and so on. Herein, the association ID (AID) refers to a specific identifier that is assigned to each user equipment in order to allow the AP to identifier each of the multiple user equipment, after the association between the AP and the user equipments is established.

2. WLAN AP Re-Selection Method

Conventionally, when a user equipment intends to shift (or move) from one specific WLAN AP to another WLAN AP, since the user equipment is required to disconnect the connection between the user equipment and the current WLAN AP and to establish a new connection with the WLAN AP to which the user equipment wishes to newly access, a considerable amount of delay may occur. Additionally, when access to the WLAN AP is intended to be established, since a TCP/IP (Transfer Control Protocol/Internet Protocol) connection is required to be newly established by performing an association procedure and an authentication procedure, a considerable amount of delay may occur with respect to the WLAN AP access.

In order to resolve such problems, in the present invention, before the user equipment reselects the WLAN AP, if the user equipment accesses the corresponding WLAN AP, after forwarding in advance information related to the access of the user equipment to the WLAN AP, to which the user equipment intends to shift, through the cellular communication network, and after completing in advance the procedures that are required for the re-access (association and authentication), communication may be quickly resumed. At this point, a process of transmitting in advance traffic data related to the user equipment to the WLAN AP, to which the user equipment intends to shift, may be included.

More specifically, when a communication user equipment, which can communication by using both the cellular mobile communication method and the WLAN communication method, is accessing both a cellular mobile communication network and a WLAN, in a situation where the user equipment intends to perform communication by performing WLAN AP reselection (WLAN AP reselection) from the currently accessed WLAN AP to another WLAN AP, the present invention relates to a method enabling the user equipment to quickly resume communication without delay, when the user equipment has reselected the WLAN AP, by delivering in advance information related to WLAN AP re-access to the WLAN AP, to which the user equipment intends to shift, through the currently accessed cellular network, and by transmitting in advance the data traffic related to the corresponding user equipment to the WLAN AP, to which the user equipment intends to shift.

Hereinafter, in this specification, it will be assumed that the user equipment corresponds to a user equipment that is equipped with a RAT (RAT Radio Access Technology) function allowing communication to be established by using a cellular mobile communication method and a RAT function allowing communication to be established by using a WLAN communication method. Additionally, for simplicity in the description, the WLAN AP to which the user equipment is currently access is referred to as a serving WLAN AP, and the WLAN AP to which the user equipment wishes (or intends) to newly access is referred to as a target WLAN AP.

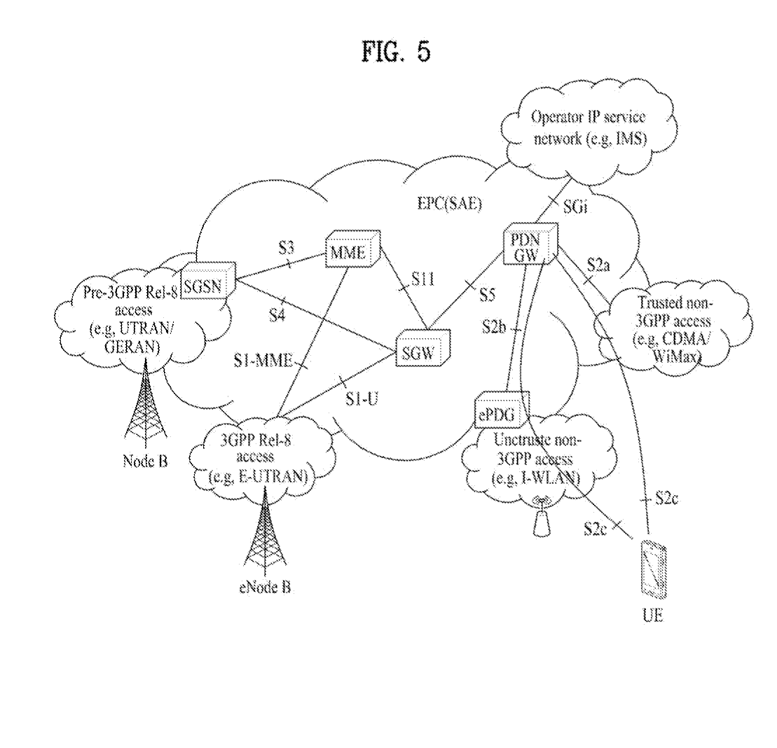

Additionally, it will be assumed that the WLAN AP according to the present invention has its location registered by a specific mobile communication operator (or manager), that the WLAN AP corresponds to a WLAN AP that can be controlled by a base station or by a mobile core network having a base station accessed thereto, and that the base station and the WLAN AP are interconnected in a state of being capable of communicating with one another through a specific network. Although an exemplary structure of a network to which the present invention may be applied is given as an example in FIG. 5 shown below, the network structure will not be limited only to this, and the present invention may be applied to any wireless (or radio) communication system supporting a heterogeneous (multi) radio access network.

FIG. 5 illustrates an exemplary structural diagram of a network to which the present invention may be applied.

In order to respond to several forums and new technologies related to 4^{th} generation mobile communication, as an effort to optimize and enhance the performance of 3GPP technologies from the end of year 2004, 3GPP, which establishes a technical standard of 3^{rd} generation mobile communication systems, has initiated research on LTE/SAE (Long Term Evolution/System Architecture Evolution) technologies.

SAE, which is developed based upon 3GPP SA WG2, corresponds to a research related to network technologies targeted to decide a network structure by alternating processes with LTE processes of 3GPP TSG RAN and to support mobility between heterogeneous networks, and the SAE corresponds to one of the most important standardization issues in recent 3GPP. As a process for evolving the 3GPP system to an IP (Internet Protocol) based system supporting diverse radio access technologies, the processes of the SAE have been carried out to target an optimized packet based system minimizing transmission delay with a more enhanced data transmission capability.

An SAE higher level reference model, which is defined in 3GPP SA WG2, includes a non-roaming case and a roaming case respective to diverse scenarios, and reference may be made to 3GPP standard documents TS 23.401 and TS 23.402 for detailed description of the same. A brief reconfiguration of the SAE higher level reference model is shown in the network structure diagram of FIG. 5, which shows a general structure of an EPS (Evolved Packet System) including EPC (Evolved Packet Core).

The EPC corresponds to an essential element of an SAE (system Architecture Evolution) for enhancing the performance of 3GPP technologies. SAE corresponds to a research project for deciding a network structure that supports the mobility between diverse types of networks. The SAE, for example, is targeted to provide a packet based system that is optimized for supporting diverse radio access technologies based on IP and for providing a more enhanced data transmission capability.

More specifically, EPC corresponds to a Core Network of an IP mobile communication system for a 3GPP LTE system, and the EPC may support packet-based real time and non-real time services. In the conventional mobile communication system (i.e., 2^{nd} generation or 3^{rd} generation mobile communication system), the core network structure was realized through 2 different sub-domains, such as CS (Circuit-Switched) for sound and PS (Packet-Switched) for data. However, in the 3GPP LTE system, which corresponds to an evolved version of the 3^{rd} generation mobile communication system, the CS and PS sub-domains have been unified to a single IP domain. More specifically, in the 3GPP LTE system, a connection between user equipment and user equipment each having IP capability may be configured through an IP based base station (e.g., eNodeB (evolved Node B)), EPC, application domain (e.g., IMS (IP Multimedia Subsystem)). More specifically, the EPC corresponds to a structure that is essential for the realization of an end-to-end IP service.

The EPC may include diverse elements, and FIG. 5 shows an example of SGW (Serving Gateway), PDN GW (Packet Data Network Gateway), MME (Mobility Management Entity), SGSN (Serving GPRS (General Packet Radio Service) Supporting Node), ePDG (enhanced Packet Data Gateway), which correspond to some of the diverse elements.

SGW operates as a boundary point between a RAN (Radio Access Network) and a Core Network, and SGW corresponds to an element that performs a function of maintaining a data path between the eNodeB and the PDN GW. Additionally, in case the user equipment is moved along an area that is served by the eNodeB, the SGW performs the function of a local mobility anchor point. More specifically, for mobility within an E-UTRAN (Evolved-UMTS (Universal Mobile Telecommunication System) Terrestrial Radio Access Network that is defined after 3GPP release-8), packets may be routed through the SGW. Additionally, the SGW may also function as an anchor point for the mobility with another 3GPP network (a RAN that is defined prior to 3GPP release-8, e.g., UTRAN or GERAN (GSM (Global System for Mobile Communication)/EDGE (Enhanced Data rates for Global Evolution) Radio Access Network).

PDN GW (or P-GW) corresponds to a termination point of a data interface directed to a packet data network. PDN GW may support policy enforcement features, packet filtering, charging support, and so on. Additionally, PDN GW may function as an anchor point for mobility management between a 3GPP network and a non-3GPP network (e.g., a non-reliable network, such as I-WLAN (Interworking Wireless Local Area Network) and a reliable network, such as CDMA (Code Division Multiple Access) network or WiMax).

In the exemplary network structure of FIG. 5, although SGW and PDN GW are illustrated to be configured as separate gateways, two gateways may be configured in accordance with a Single Gateway Configuration Option.

MME corresponds to an element performing signaling and control functions for supporting access to a network connection of a user equipment, allocation of network resources, tracking, paging, roaming, and handover, and so on. MME controls control plane functions related to subscriber and session management. MME manages an extended number of eNodeBs and performs signaling for the selection of related art gateways for the handover respective to other 2G/3G networks. Additionally, MME performs the functions of Security Procedures, Terminal-to-network Session Handling, Idle Terminal Location Management, and so on.

SGSN performs handling of all packet data, such as user mobility management and authentication respective to another 3GPP network (e.g., GPRS network).

ePDG performs a function of a security node respective to a non-reliable non-3GPP network (e.g., I-WLAN, WiFi hotspot, and so on).

As described above with reference to FIG. 5, a user equipment having an IP capability may access a service provider (i.e., an IP service network (e.g., IMS) provided by an operator) after passing through diverse elements within the EPC based upon a 3GPP access as well as a non-3GPP access.

Additionally, FIG. 5 illustrates diverse reference points (e.g., S1-U, S1-MME, and so on). In the 3GPP system, a conceptual link connecting 2 functions existing in different functional entities of E-UTRAN and EPC is defined as a reference point. Among the reference points shown in FIG. 5, S2a and S2b correspond to non-3GPP interfaces. S2a corresponds to a reference point providing related control and mobility support between a reliable non-3GPP access and a PDNGW to a user plane. S2b corresponds to a reference point providing related control and mobility support between an ePDG and a P-GW to a user plane. S2c corresponds to a reference point between a user equipment (UE) and a P-GW.

As described above, in addition to a GTP (GPRS Tunneling Protocol) protocol, which has been traditionally used in the conventional 3GPP while supporting non-3GPP interworking, the adoption of other diverse protocols of IETF (Internet Engineering Task Force) has been realized. Most particularly, IETF protocols of PMIPv6 (Proxy Mobile IPv6) and DSMIPv6 (Dual Stack Mobile IPv6), and so on, have been adopted in a draft version state prior to RFC (Request for Comments) of the IETF and is being used as a crucial protocol of non-3GPP interoperability in the current SAE standard. Essentially, a GTP protocol is used for inter-3GPP RAT (Inter-Radio Access Technology) handover, and IETF-based protocols are used for S2 interfaces for non-3GPP interoperability. Most particularly, reference point S5, which provides User Plane tunneling and tunnel management between an SGW and a P-GW and reference point S8 (not shown), which is used when performing roaming, may both support GTP and IETF-based protocols.

Hereinafter, an exemplary embodiment of a method of delivering (or transmitting) information related to WLAN AP re-access to a WLAN AP that is targeted for shifting through a cellular network during the WLAN AP re-selection procedure of the user equipment will be described.

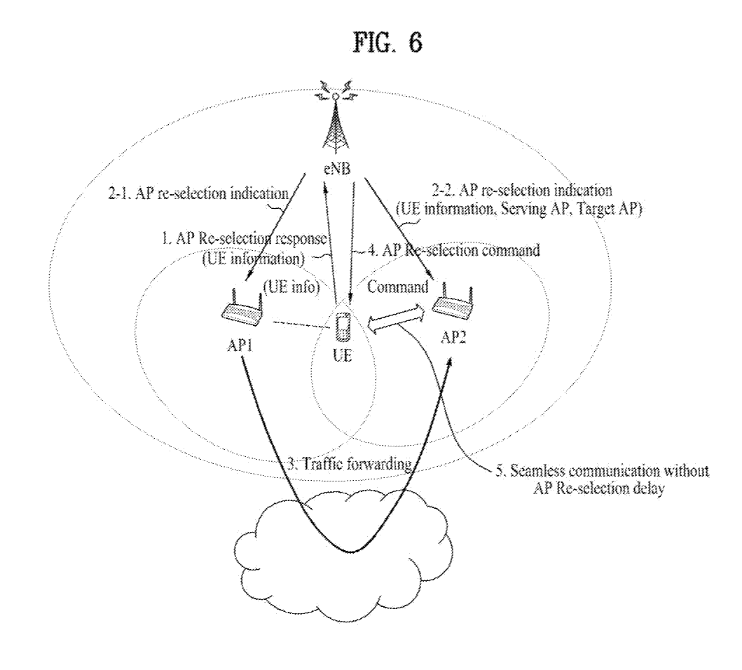

FIG. 6 illustrates an example of a WLAN AP re-selection process according to an exemplary embodiment of the present invention.

FIG. 6 corresponds to a schematic view of a procedure of transmitting in advance information on an access change to a target WLAN AP through a cellular network and a procedure of also forwarding (or delivering) data traffic to the target WLAN AP, in case a user equipment, which is accessing the cellular network and the WLAN, intends (or wishes) to change (or shift) its access to the searched target WLAN AP, so as to perform communication. As described above, by performing in advance a preparatory procedure for shifting access to a target WLAN AP, prior actually shifting its access to the target WLAN AP, the user equipment may perform seamless communication without any delay respective to the access change (or shift).

1) In case a signal quality of a target WLAN AP (AP 2), which has been searched from beacon signals that are periodically transmitted from neighboring WLAN APs, is better than a signal quality of a serving WLAN AP (AP 1), the user equipment transmits an AP reselection response message, which includes information on itself (the user equipment), to the base station, thereby requesting an access shift to the target WLAN AP. Herein, the WLAN AP reselection method may be initiated by the base station. In case the WLAN AP reselection method is initiated by the base station, a procedure of having the base station request the user equipment to perform AP reselection by transmitting an AP reselection request message to the user equipment may be further included, and the user equipment may transmit an AP reselection response including information on itself (the user equipment) to the base station, as a response to the AP reselection request message. In order to do so, the user equipment periodically delivers (or forwards) a neighbor cell report message, which includes an identifier of the neighbor WLAN AP searched by the user equipment and information on a signal intensity of each neighbor WLAN AP, to the base station.

2-1, 2-2) The base station directs the serving WLAN AP (AP 1) and the target AP (AP 2) to perform the preparatory procedure for the AP reselection of the user equipment by transmitting an AP reselection indication message to the serving WLAN AP (AP 1) and the target AP (AP 2). Herein, the AP reselection indication message, which is transmitted to the target WLAN AP (AP 2) may include information on the user equipment, information on the serving WLAN AP to which the user equipment is currently accessing, and information on the target WLAN AP to which the user equipment wishes to access through AP reselection, along with information required for association of the user equipment and information required for connection setup.

3) After receiving the AP reselection indication message from the base station, the serving WLAN AP forwards data traffic of the current user equipment to the target WLAN AP (traffic forwarding), and the target WLAN AP stores the data traffic of the user equipment, which is received from the serving WLAN AP, in a buffer until access of the user equipment is established.

4) The base station transmits an AP reselection command message commanding (or ordering) the WLAN AP reselection procedure to be performed to the user equipment. Herein, the base station may transmit the AP reselection command message to the user equipment after verifying that the procedure for the AP reselection of the user equipment has been completed, by receiving an AP change setup complete message from the target WLAN AP (AP 2).

5) After receiving the AP reselection command message from the base station, the user equipment disconnects its access to the serving WLAN AP (AP 1) and performs data transmission to the target WLAN AP (AP 2). Herein, since the information required for association of the user equipment and the information required for connection setup have all been forwarded (or delivered) to the target WLAN AP (AP 2), the user equipment may perform data transmission to the target WLAN AP (AP 2) after searching for a signal of the target WLAN AP (AP 2), without any association process with the target WLAN AP (AP 2) and performing synchronization with the target WLAN AP (AP 2).

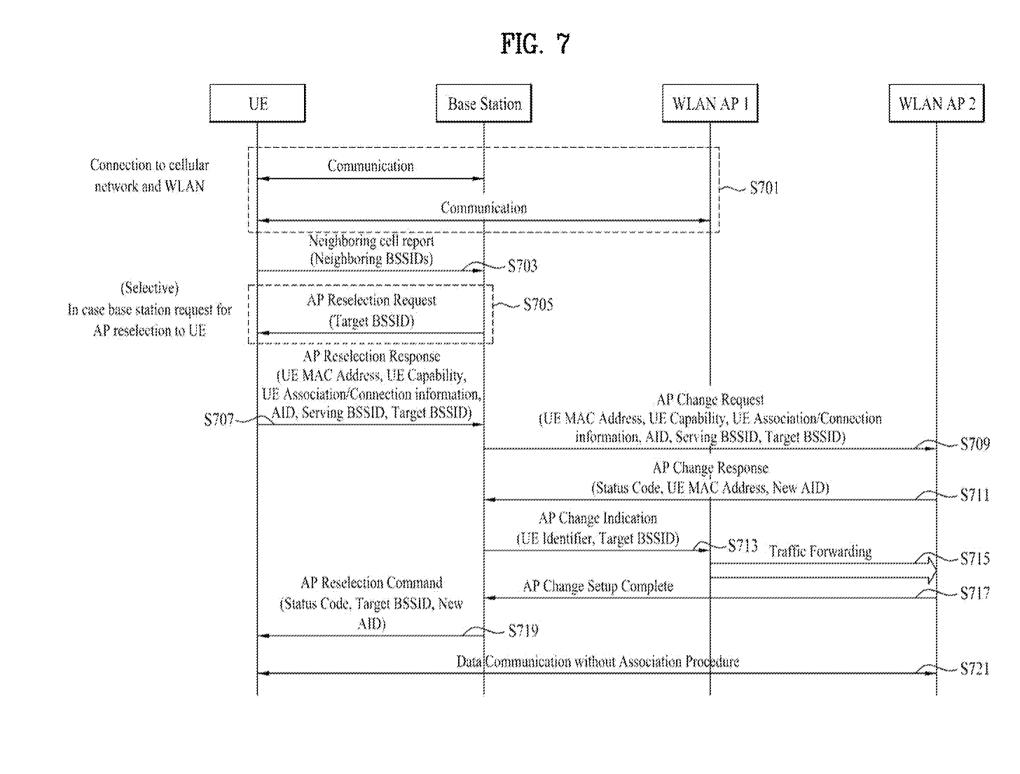

FIG. 7 illustrates an exemplary procedure of WLAN AP re-selection according to an exemplary embodiment of the present invention.

Referring to FIG. 7, the user equipment periodically searches for a neighboring WLAN AP that is available for communication, while the user equipment is performing communication by accessing both the cellular network and the WLAN AP (S701). Herein, the method of each user equipment for searching for the corresponding WLAN AP may be performed by searching for a beacon frame, which is periodically transmitted by the WLAN AP, and by receiving the beacon frame.

As described above, the beacon frame may include information, such as time stamp, beacon interval, AP capability, SSID (Service Set Identifier), and supported rates, and so on. The SSID (Service Set Identifier) corresponds to an identifier that is used for identifying multiple basic service sets each being different from one another in a WLAN system, and the SSID may also be referred to as a basic service set identifier (BSSID).

After searching the WLAN AP, the user equipment transmits an ID (identifier) of the searched WLAN AP to the base station through a neighbor cell report message (S703). More specifically, after receiving the beacon frame from the WLAN AP, among the information within the received beacon frame, the user equipment may transmit the BSSID of the WLAN AP, which has transmitted the corresponding beacon frame, to the base station through the neighbor cell report message.

The neighbor cell report message may include identifier information of one or more WLAN APs. Additionally, the neighbor cell report message may also optionally include AP capability information, supported rate information, and so on, which are included in the beacon frame. Moreover, the neighbor cell report message may be included in a neighbor base station report message of a conventional cellular network, which is included in the base station, and may then be transmitted, and the neighbor cell report message may also be transmitted separately from the neighbor base station report message of the conventional cellular network. Herein, in case the neighbor cell report message is transmitted separately from the neighbor base station report message of the conventional cellular network, the neighbor cell report message may be configured to have the same format as the neighbor base station report message of the conventional cellular network. Furthermore, in order to be differentiated from the neighbor base station report message of the conventional cellular network, indication information may be included in the message.

Meanwhile, since the user equipment periodically searches for neighboring WLAN APs, the user equipment may periodically transmit a neighbor cell report message including the identification information respective to the searched WLAN AP to the base station. Additionally, the neighbor cell report message may also be transmitted to the base station only when the searched neighbor WLAN AP is changed due to a change in the mobility or channel status of the user equipment.

After receiving the neighbor cell report message from the user equipment, when the base station determines that the signal quality of the WLAN AP, which is searched by the user equipment, is better than the signal quality of the serving WLAN AP (WLAN AP 1) to which the user equipment is currently accessing, or when the base station determines that the user equipment is required to perform WLAN AP reselection from the serving WLAN AP to the WLAN AP, which is searched by the user equipment, for reasons of distributing traffic of the serving WLAN AP, and so on, the base station transmits an AP reselection request message to the user equipment (S705). Herein, the AP reselection request message may include a BSSID of the target WLAN AP (WLAN AP 2).

The WLAN AP reselection method that is proposed in the present invention may either be initiated by the base station or be initiated by the user equipment. In case the method is initiated by the user equipment, step S705 may be omitted.

In case the WLAN AP reselection is initiated by the base station, in step S705, an AP reselection request message may be received from the base station, or, in case the WLAN AP reselection is initiated by the user equipment, when the user equipment itself wishes a WLAN AP, the user equipment transmits an AP reselection response message to the base station so as to request for an access change to the target WLAN AP (WLAN AP 2) (S707). As described above, in case the WLAN AP reselection is initiated by the user equipment, the AP reselection response message may be referred to as an AP reselection request message, and, step S703, wherein the user equipment transmits the neighbor cell report message to the base station, may also be omitted.

The AP reselection response message may include at least any one of a user equipment identifier, user equipment capability information, user equipment association information, user equipment connection information, association identifier (AID) with the serving WLAN AP (WLAN AP 1), a BSSID of the serving WLAN AP (WLAN AP 1), and a BSSID of a target WLAN AP (WLAN AP 2). Herein, a MAC address of the user equipment may be used as an example of the identifier of the user equipment. The MAC address refers to an address having the length of 48 bits, which is assigned to each communication device (WLAN network adaptor equipped to the device), and the corresponding address is a globally unique address. The user equipment connection information refers to TCP/IP connection information that is communicated by the user equipment through the serving WLAN AP (WLAN AP 1) and information for maintaining the corresponding connection. For example, in case a MAC address, an IP address, a Subnet Mask, a DHCP of a network adapter are available, a Gateway address and an IP address of a DHCP server, and so on, may be included. The user equipment association information refers to information related to the association between the user equipment and the serving WLAN AP (WLAN AP 1). The association identifier (AID) refers to an identifier that is allocated (or assigned) to the user equipment by the serving WLAN AP (WLAN AP 1) for communication after the association between the user equipment and the serving WLAN AP (WLAN AP 1). The user equipment capability information refers to information on a capability (or function) of the user equipment that can be used by the user equipment for WLAN access. The user equipment capability information, user equipment association information, user equipment connection information, BSSID of the serving WLAN AP (WLAN AP 1), BSSID of a target WLAN AP (WLAN AP 2), and association identifier (AID) may follow the respective formats defined in the IEEE 802.11 standard document.

After receiving the AP reselection response message from the user equipment, the base station transmits an AP change request message to the target WLAN AP (WLAN AP 2), so as to notify the target WLAN AP (WLAN AP 2) that the user equipment has requested an AP access change (S709).

The AP change request message may include at least any one of an identifier of the user equipment (e.g., a MAC address of the user equipment), user equipment capability information, user equipment association information, user equipment connection information, association identifier (AID) with the serving WLAN AP (WLAN AP 1), a BSSID of the serving WLAN AP (WLAN AP 1), and a BSSID of a target WLAN AP (WLAN AP 2). The information included in the AP change request message may be identical to the information included in the AP reselection response message, which is transmitted to the base station by the user equipment.

After receiving the AP change request message, the target WLAN AP (WLAN AP 2) transmits an AP change response message to the base station, so as to notify the base station whether or not the user equipment intends to accept (or approve) the access request made to the user equipment itself (S711).

The AP change response message may include at least any one of information on whether or not the user equipment intends to accept the access request (status code), and an identifier of the user equipment. Additionally, the AP change response message may selectively include a new association identifier (AID) in case an association identifier (AID), which is different from the association identifier (AID) respective to the user equipment access from the serving WLAN AP (WLAN AP 1), is required to be assigned to the user equipment. More specifically, in case a new association ID (AID) is not included in the AP change response message, the association identifier (AID) that is assigned to the user equipment by the serving WLAN AP (WLAN AP 1) may be identically used.

In case the target WLAN AP (WLAN AP 2) rejects (or denies) the access request of the user equipment, the base station may transmit to the user equipment a message for notifying that the target WLAN AP (WLAN AP 2) has rejected the access request of the user equipment. Herein, the message for notifying that the target WLAN AP (WLAN AP 2) has rejected the access request of the user equipment may include information indicating whether or not the AP reselection request has been accepted by the target WLAN AP (WLAN AP 2), i.e., a status code included in the AP change response message.

Thereafter, by selecting another WLAN AP as the target WLAN AP and by transmitting a reselection response message to the base station, the user equipment may re-perform (or repeat) the WLAN AP reselection procedure. Herein, after re-searching for a neighboring WLAN AP, by selecting another WLAN AP from the re-searched WLAN APs as the new target WLAN AP, the user equipment may repeat the procedure from step S701, or by selecting another WLAN AP from the already searched WLAN APs as the new target WLAN AP, the user equipment may repeat the procedure from step S707. Additionally, after receiving an AP change response message rejecting the access request of the user equipment from the target WLAN AP (WLAN AP 2), by selecting another WLAN AP included in the neighbor cell report message, which is transmitted from the user equipment, as the new target WLAN AP and by transmitting an AP reselection request message to the user equipment, the base station may repeat the procedure starting from step S705.

Hereinafter, for simplicity in the description, a case when it is assumed that the target WLAN AP (WLAN AP 2) transmits an AP change response message, which indicates that the target WLAN AP (WLAN AP 2) has accepted the access of the user equipment, to the base station will be described.

After receiving the AP change response message, in case the target WLAN AP (WLAN AP 2) has authorized the access request of the user equipment, the base station may transmit an AP change indication message to the serving WLAN AP (WLAN AP 1), so as to notify the serving WLAN AP (WLAN AP 1) that the user equipment will change its access to the target WLAN AP (WLAN AP 2) (S713).

The AP change indication message may include indication information for notifying or for indicating that the user equipment will change its access to the target WLAN AP (WLAN AP 2).

After receiving the AP change indication message from the base station, the serving WLAN AP (WLAN AP 1) forwards the data traffic of the user equipment to the target WLAN AP (WLAN AP 2) (traffic forwarding), while continuing to perform communication with the corresponding user equipment (S715). Herein, the target WLAN AP (WLAN AP 2) receiving data traffic of the user equipment from the serving WLAN AP (WLAN AP 1) buffers the data traffic of the user equipment in the memory until access between the user equipment and the target WLAN AP (WLAN AP 2) is established.

Additionally, the target WLAN AP (WLAN AP 2) begins to receive the data traffic of the user equipment from the serving WLAN AP (WLAN AP 1), the target WLAN AP (WLAN AP 2) transmits an AP change setup complete message to the base station, so as to notify that all preparations respective to the access of the user equipment have been completed (S717).

The AP change setup complete message may include indication information indicating that all preparations respective to the access of the user equipment have been completed by the target WLAN AP (WLAN AP 2).

After receiving the AP change setup complete message from the target WLAN AP (WLAN AP 2), the base station may transmit an AP reselection command message to the user equipment, so as to notify that the access change request to the target WLAN AP (WLAN AP 2) requested by the user equipment has been accepted and to notify that preparations for the corresponding access change have been completed (S919).

The AP reselection command message may include information indicating whether or not the AP reselection request has been accepted by the target WLAN AP (WLAN AP 2), i.e., a status code included in the AP change response message. Additionally, in case a new association identifier (AID) has been assigned to the user equipment by the target WLAN AP (WLAN AP 2), a new association identifier may be included.

After receiving the AP reselection command message, the user equipment disconnects its access to the serving WLAN AP (WLAN AP 1) and searches for a signal of the target WLAN AP (WLAN AP 2), so as to perform synchronization, and then performs data transmission (S721). Herein, since the information required for the association of the user equipment and the information required for the connection setup have already been forwarded to the target WLAN AP (WLAN AP 2) during an information exchange between the serving WLAN AP (WLAN AP 1) or the base station and the target WLAN AP (WLAN AP 2), the user equipment may seamlessly perform data communication with the target WLAN AP (WLAN AP 2) without performing an association procedure.

Meanwhile, the above-described step S717 may also be omitted. More specifically, after transmitting an AP change indication to the serving WLAN AP (WLAN AP 1) in step S713, by transmitting an AP reselection command message to the user equipment, the base station may perform the procedure starting from step S719. At this point, step S713 and step S719 may be performed at the same time point.

3. General Description of a Device to which the Present Invention May be Applied

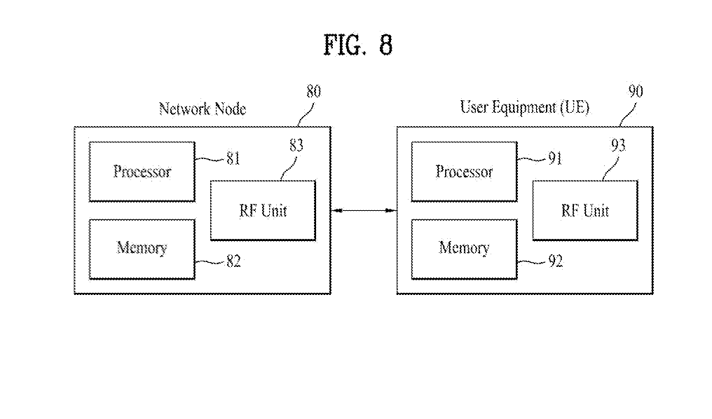

FIG. 8 illustrates a block view of a structure of a wireless communication device according to an exemplary embodiment of the present invention.

Referring to FIG. 8, a wireless communication device includes a network node (80) and multiple user equipments (90) located within the network node (80) area. Herein, in the above-described exemplary embodiment, the network node (80) may correspond to a base station or a WLAN AP.

The network node (80) includes a processor (81), a memory (82), and an RF unit (radio frequency unit) (83). The processor (81) realizes the proposed functions, procedures, and/or methods. Layer of the wireless interface protocol may be realized by the processor (81). The memory (82) is connected to the processor (81) and stores diverse information for operating the processor (81). The RF unit (83) is connected to the processor (81) and transmits and/or receives radio signals.

The user equipment (90) includes a processor (91), a memory (92), and an RF module (93). The processor (91) realizes the proposed functions, procedures, and/or methods. Layer of the wireless interface protocol may be realized by the processor (91). The memory (92) is connected to the processor (91) and stores diverse information for operating the processor (91). The RF unit (93) is connected to the processor (91) and transmits and/or receives radio signals.

The memory (82, 92) may be provided inside or outside of the processor (81, 91) and may be connected to the processor (81, 91) through diverse well-known means. Furthermore, the network node (80) and/or the user equipment (90) may have a single antenna or multiple antennae.

The above-described embodiments of the present invention correspond to predetermined combinations of elements and features and characteristics of the present invention. Moreover, unless mentioned otherwise, the characteristics of the present invention may be considered as optional features of the present invention. Herein, each element or characteristic of the present invention may also be operated or performed without being combined with other elements or characteristics of the present invention. Alternatively, the embodiment of the present invention may be realized by combining some of the elements and/or characteristics of the present invention. Additionally, the order of operations described according to the embodiment of the present invention may be varied. Furthermore, part of the configuration or characteristics of any one specific embodiment of the present invention may also be included in (or shared by) another embodiment of the present invention, or part of the configuration or characteristics of any one embodiment of the present invention may replace the respective configuration or characteristics of another embodiment of the present invention. Furthermore, it is apparent that claims that do not have any explicit citations within the scope of the claims of the present invention may either be combined to configure another embodiment of the present invention, or new claims may be added during the amendment of the present invention after the filing for the patent application of the present invention.

The above-described embodiments of the present invention may be implemented by using a variety of methods. For example, the embodiments of the present invention may be implemented in the form of hardware, firmware, or software, or in a combination of hardware, firmware, and/or software. In case of implementing the embodiments of the present invention in the form of hardware, the method according to the embodiments of the present invention may be implemented by using at least one of ASICs (Application Specific Integrated Circuits), DSPs (Digital Signal Processors), DSPDs (Digital Signal Processing Devices), PLDs (Programmable Logic Devices), FPGAs (Field Programmable Gate Arrays), processors, controllers, micro controllers, micro processors, and so on.

In case of implementing the embodiments of the present invention in the form of firmware or software, the method according to the embodiments of the present invention may be implemented in the form of a module, procedure, or function performing the above-described functions or operations. A software code may be stored in a memory unit and driven by a processor. Herein, the memory may be located inside or outside of the processor, and the memory unit may transmit and receive data to and from the processor by using a wide range of methods that have already been disclosed.

The present invention may be realized in another concrete configuration (or formation) without deviating from the scope and spirit of the essential characteristics of the present invention. Therefore, in all aspect, the detailed description of present invention is intended to be understood and interpreted as an exemplary embodiment of the present invention without limitation. The scope of the present invention shall be decided based upon a reasonable interpretation of the appended claims of the present invention and shall come within the scope of the appended claims and their equivalents. Therefore, it is intended that the present invention covers the modifications and variations of this invention provided they come within the scope of the appended claims and their equivalents, and it is not intended to limit the present invention only to the examples presented herein.

### INDUSTRIAL APPLICABILITY

Although a method for transmitting data in a wireless communication system of the present invention is described based upon an example that can be applied to a 3GPP LTE system and an IEEE 802.11 system, the method of the present invention may also be applied to a variety of other radio access system in addition to the 3GPP LTE system and the IEEE 802.11 system.

What is claimed is:

1. A method for reselecting a WLAN (Wireless Local Area Network) AP (Access Point) in a wireless communication system supporting multi Radio Access Network, the AP reselection method performed by a base station and comprising:
receiving an AP reselection response message requesting access to be changed from a first WLAN AP to a second WLAN AP from a user equipment accessing the first WLAN AP;
transmitting an AP change request message including information related to association of the user equipment and information related to connection setup to the second WLAN AP;
receiving an AP change response message including information indicating whether or not access of the user equipment has been approved from the second WLAN AP;
transmitting an AP change indication message for indicating access change of the user equipment to the first WLAN AP, when the second WLAN AP has approved the access; and
transmitting an AP reselection command message commanding access to the second WLAN AP to the user equipment.

2. The method of claim 1, further comprising:
receiving a neighboring cell report message including an identifier of a WLAN AP searched by the user equipment and signal intensity information from the user equipment.

3. The method of claim 2, further comprising:
transmitting an AP reselection request message requesting for an access change from the first WLAN AP to the second WLAN AP to the user equipment, when the user equipment requires access to be changed from the first WLAN AP to the second WLAN AP, based upon the neighboring cell report message.

4. The method of claim 1, further comprising:
receive an AP change setup complete message indicating that preparations required for the access of the user equipment have been completed from the second WLAN AP, when data of the user equipment begin to be forwarded to the second WLAN AP from the first WLAN AP.

5. The method of claim 1, wherein the AP reselection response message further includes at least an identifier of the user equipment, capability information of the user equipment, association identifier (AID) with the first WLAN AP, an identifier of the first WLAN AP, or an identifier of the second WLAN AP.

6. The method of claim 5, wherein the AP change request message includes information that is identical to information included in the AP reselection response message.

7. The method of claim 1, wherein the AP change response message includes an AID (Association Identifier) of the user equipment.

8. The method of claim 7, wherein the AP reselection command message includes information indicating whether or not access of the user equipment has been approved by the second WLAN AP and an AID (Association Identifier) of the user equipment.

9. As a base station performing WLAN (Wireless Local Area Network) AP (Access Point) reselection in a wireless communication system supporting multi Radio Access Network, the base station comprising:
an RF (Radio Frequency) unit configured to transceive a radio signal; and
a processor configured to:
receive an AP reselection response message requesting access to be changed from a first WLAN AP to a second WLAN AP from a user equipment accessing the first WLAN AP,
transmit an AP change request message including information related to association of the user equipment and information related to connection setup to the second WLAN AP,
receive an AP change response message including information indicating whether or not access of the user equipment has been approved from the second WLAN AP,
transmit an AP change indication message for indicating access change of the user equipment to the first WLAN AP, when the second WLAN AP has approved the access, and
transmit an AP reselection command message commanding access to the second WLAN AP to the user equipment.

10. The base station of claim 9, wherein the processor receives a neighboring cell report message including an identifier of a WLAN AP searched by the user equipment and signal intensity information from the user equipment.

11. The base station of claim 10, wherein, when the user equipment requires access to be changed from the first WLAN AP to the second WLAN AP, based upon the neighboring cell report message, the processor transmits an AP reselection request message requesting for an access change from the first WLAN AP to the second WLAN AP to the user equipment.

12. The base station of claim 9, wherein, when data of the user equipment begin to be forwarded to the second WLAN AP from the first WLAN AP, the processor receives an AP change setup complete message indicating that preparations required for the access of the user equipment have been completed from the second WLAN AP.

13. The base station of claim 9, wherein the AP reselection response message further includes at least an identifier of the user equipment, capability information of the user equipment, association identifier (AID) with the first WLAN AP, an identifier of the first WLAN AP, or an identifier of the second WLAN AP.

14. The base station of claim 13, wherein the AP change request message includes information that is identical to information included in the AP reselection response message.

15. The base station of claim 9, wherein the AP change response message includes an AID (Association Identifier) of the user equipment.

16. The base station of claim 15, wherein the AP reselection command message includes information indicating whether or not access of the user equipment has been approved by the second WLAN AP and an AID (Association Identifier) of the user equipment.
